(19) United States
(12) Patent Application Publication
(10) Pub. No.: US 2007/0087240 A1
(43) Pub. Date: Apr. 19, 2007

(54) Fuel cell fluid dissipater

(75) Inventors: Curtis Michael Robin, Vancouver (CA); Alan John Mulvenna, Vancouver (CA); Gerhard Michael Schmidt, Vancouver (CA)

Correspondence Address: GOWLING LAFLEUR HENDERSON LLP, P.O. BOX 49122, 2300-1055 DUNSMUIR ST., VANCOUVER, BC, V7X 1J1, CA

(73) Assignee: General Hydrogen Corporation

(21) Appl. No.: 11/360,486

(22) Filed: Feb. 24, 2006

Related U.S. Application Data
(63) Continuation-in-part of application No. 11/251,792, filed on Oct. 18, 2005.

(51) Int. Cl. H01M 8/04

(52) U.S. Cl. 429/26; 429/34; 429/22

(57) ABSTRACT

A fuel cell fluid dissipater dissipates excess air, water and unreacted fuel from a fuel cell and comprises a gas permeable and water absorbing dissipation media and a fluid intake assembly. The fluid intake assembly directs excess water and unreacted fuel and air from the fuel cell to the dissipation media where the excess water is directed to a bottom portion of the dissipation media and where the unreacted fuel and air are directed to a top portion of the dissipation media. An air stream is directed through the dissipation media such that the excess water and unreacted fuel and air in the media are dissipated to the environment.

### RELATED APPLICATION

This application is a continuation-in-part of U.S. application Ser. No. 11/251,792 “Fuel Cell Fluid Management System” to Mulvenna et al., filed on Oct. 18, 2005 and which is incorporated herein by reference in its entirety and for all teachings, disclosures and purposes.

### TECHNICAL FIELD

The present invention relates generally to a fluid dissipater for a fuel cell generator.

### BACKGROUND OF THE INVENTION

Fuel cells produce electricity from an electrochemical reaction between a hydrogen-containing fuel and oxygen. Fuel cell exhaust comprises oxidant and water and some waste heat, provided that pure hydrogen is used.

One type of fuel cell is a proton-exchange-membrane (PEM) fuel cell. PEM fuel cells are typically combined into fuel cell stacks to provide a greater voltage than can be generated by a single fuel cell. Fuel cell stacks are typically provided with manifolds that distribute fluid to and collect fluid from all of the constituent fuel cells. The manifolds are provided with ports for coupling to external fluid supply circuits, external fluid exhaust circuits and external fluid circulating circuits.

The fuel used by a PEM fuel cell is typically a gaseous fuel, and the gaseous fuel is typically hydrogen, but may be another hydrogen-containing fuel, such as reformate. In a typical PEM fuel cell, a chamber of hydrogen gas is separated from a chamber of oxidant gas by a proton-conductive membrane that is impermeable to oxidant gases. The membrane is typically formed of NAFION® polymer manufactured by DuPont or some similar ion-conductive polymer. NAFION polymer is highly selectively permeable to water when exposed to gases.

In order for the fuel cell membrane to function properly, the membrane must be hydrated; in typical PEM fuel cells, water vapor is continuously added to the fuel supply stream and to the oxidant supply stream in order to keep the fuel cell membranes hydrated. Fuel cells release more water into an exhaust stream than added to the fuel supply stream, as hydrogen atoms and oxygen atoms combine to produce water in the electrochemical reaction of the fuel cell. As water permeates very readily through the membrane separating the fuel and the oxidant, sufficient water can return from the oxidant side of the membrane to the fuel side by simple permeation as long as the high water concentration on the oxidant side is maintained.

Fuel cells often operate using air as the oxidant, relying upon the approximately 20% oxygen in ambient air. The use of air as an oxygen source requires a flow rate of about air five times that required for oxygen. When ambient air is used as an oxygen source, this high flow rate dries out the membrane by diluting the water vapor concentration on the oxidant exhaust side of the membrane. If water can be recovered from the oxidant exhaust, the need for a separate water supply to keep the membrane hydrated for proper permeation of hydrogen can theoretically be eliminated.

Numerous system and methods for recirculating water vapour from exhaust gas streams to supply gas streams have been described. US patent application 2002/0155328 to Smith describes a method and apparatus that recovers and recycles water from a fuel cell exhaust and returns the water to the supply gases for the fuel cells. Particularly, water vapor is transferred from the exhaust gases to one or more supply gases by passing hot humidified exhaust gas over water permeable tubes, such that a supply gas flowing through the tubes is humidified by water permeating through the tubes and heated by heat conducted through the tubes from the exhaust gas. Commonly assigned US patent Pat. No. 6,864,005 to Mossman discloses and claims a membrane exchange humidifier, particularly for use in humidifying reactant streams for solid polymer electrolyte fuel cell systems.

A drawback of the described products is that the water available from the oxidant exhaust gas exceeds the water required for humidification of the fuel and oxidant supply gas streams, leaving excess water that needs to be disposed of. A further drawback is that excess water accumulates within the fuel cell gas supply channels after fuel cell operation is shut down, creating a surge of excess water when the fuel cell operation is re-started.

Existing solutions to dispose of excess water include storing such water in tanks for periodic discharge, and using an evaporator. Commonly assigned U.S. Pat. Nos. 6,861,167, 6,960,401, and 6,979,504 disclose a fuel cell system wherein excess liquid water is provided to an evaporator, and the evaporator function is enhanced by air blown on the evaporator by the fuel cell system's cooling fan.

Another aspect of PEM fuel cell operation involves purging the fuel path through the fuel cells to return the electrochemical reaction to full capacity. The purged fuel is typically vented from the fuel exhaust stream to the environment; however, due to the danger of creating a flammable mixture of fuel and air in the presence of a potential source of ignition, the purged fuel is diluted to below the lower flammability limit of the fuel before being exposed to a potential source of ignition, such as may be present in the environment. Known purging solutions involve dedicated components such as a purge fan and motor, additional piping etc., which add bulk and complexity to the system.

Water disposal and fuel purging equipment are collectively known as “balance of plant” components of a fuel cell system. Such components add cost, bulk, weight, and complexity to a fuel cell system; also, some components require power, and thus constitute a parasitic load on the power generation capabilities of the fuel cell system. Reducing weight and bulk are particularly important concerns when engineering fuel cell systems for use in applications were available space is at a premium.

### SUMMARY OF THE INVENTION

An object of the invention is to provide a fuel cell generator that solves at least some of the problems in the prior art. A particular objective is to provide a fuel cell generator that dissipates excess product water as well as unreacted fuel and air in a simple, cost-effective and space efficient manner.

According to one aspect of the invention, there is provided a fuel cell generator comprising a fuel cell and a fluid dissipater for dissipating fluids present in the generator. The fluid dissipater comprises a gas permeable and water absorbing evaporative media, and a fluid intake assembly fluidly coupled to the evaporative media and to the fuel cell such that water and gaseous unreacted fuel discharged by the fuel cell are directed to the evaporative media for dissipation out of the fuel cell generator. By combining fuel purge and water disposal functions of the fuel cell generator into a single apparatus, size, weight and complexity of balance of plant components in the generator can be reduced, thereby providing a cost-effective fuel cell generator that can be installed in confined spaces.

The fluid intake assembly can comprise one or more of the following components:
a water trough fluidly coupled to the fuel cell such that water discharged by the fuel cell is directed to the trough; in such case, the evaporative media is located in sufficient proximity to the trough to wick water in the trough into the media;
a gas conduit having an inlet end fluidly coupled to the fuel cell and an outlet end fluidly coupled to the evaporative media, such that the fuel discharged from the fuel cell is directed into the media;
a fluid separator having a chamber fluidly coupled to a fluid exhaust stream from the fuel cell, a water outlet for directing water that has settled in the chamber into the trough, and a gas outlet for directing fuel from the exhaust stream to the gas conduit; and/or
a fluid separation chamber fluidly coupled to the media, a gas inlet fluidly coupled to the gas conduit, a water inlet fluidly coupled to the fluid separator water outlet, and a water outlet located below the gas and water inlets and fluidly coupled to the trough.

Further, a lower portion of the media can be positioned to contact water in the trough, and an upper portion of the media can be positioned to receive fuel from the gas conduit. This arrangement is particularly useful to reduce splashing or spitting that can occur when water and gases are discharged together onto the media. Also, the dissipater can comprise multiple troughs and multiple evaporative media each located in sufficient proximity to an associated trough to wick water in the trough into the media. Using multiple such troughs and media increases the size and dissipation capacity of the dissipater.

The fuel cell generator can further comprise a fan facing the evaporative media and configured to direct an air stream through the media to dissipate water and fuel in the media out of the fuel cell generator. The oxidant intake of the fuel cell can be in fluid communication with the air stream, such that the air stream provides oxidant to the fuel cell as well as dissipates fluids contained in the dissipater. The fuel cell generator can also have a radiator thermally coupled to the fuel cell and that has heat exchanger elements located between the fan and the media such that heat is discharged from the heat exchanger elements into the air stream.

### BRIEF DESCRIPTION OF THE DRAWINGS

FIG. 1 is a schematic side view of a fuel cell generator including a fuel cell fluid dissipater according to one embodiment of the invention.

FIG. 2 is a schematic side view of a fluid separator of the dissipater shown in FIG. 1.

FIG. 3 is a sectioned edge view of a dissipation media assembly of the dissipater shown in FIG. 1.

FIG. 4 is a sectioned side view of the dissipation media assembly shown in FIG. 3.

FIG. 5 is another sectioned side view of the dissipation media assembly shown in FIG. 3.

FIG. 6 is a side view of a cooling system radiator of the fuel cell generator shown in FIG. 1.

FIG. 7 is a side view of the dissipater shown in FIG. 1.

FIGS. 8a and 8b are sectioned edge views of a dissipation media assembly of the fuel cell generator according to two other embodiments of the invention.

### DETAILED DESCRIPTION OF EMBODIMENTS OF THE INVENTION

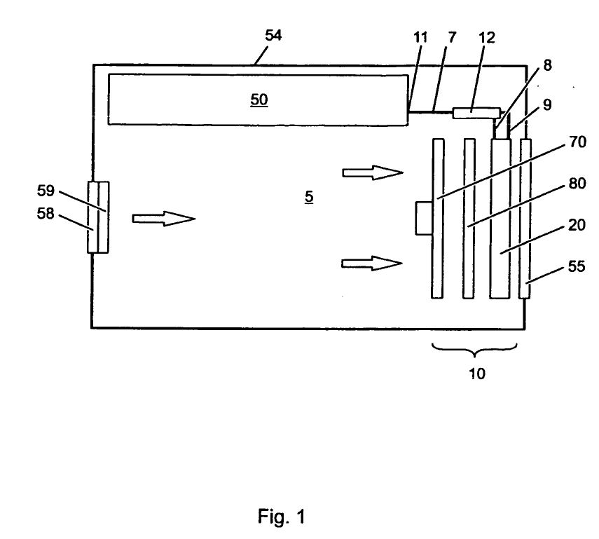

Referring to FIG. 1 and according to a preferred embodiment of the invention, a fuel cell generator 5 includes a fuel cell stack 50, a fuel cell generator enclosure 54, an enclosure air inlet 58, enclosure air outlet 55; and within the enclosure 54 an air inlet particulate filter 59, a fuel cell excess fluids outlet 11, an excess fluids conduit 7, and a fluid dissipater 10.

The fuel cell stack 50 may be any suitable PEM fuel cell stack as known in the art, such as Ballard Power System's Mark 9 series fuel cell stack. Such fuel cell stacks electrochemically react oxidant (typically from air) and gaseous hydrogen fuel to produce electricity, heat and product water; unreacted fuel, unreacted air, and excess water are typically discharged from the fuel cell.

The fluid dissipater 10 includes a fluid separator 12, an excess water conduit 8, an excess gas conduit 9, a dissipation media assembly 20, a cooling system fan 70, and a cooling system radiator 80. The fluid dissipater 10 operates to quickly and completely dissipate fluids discharged by the fuel cell stack 50, namely excess water and unreacted gaseous fuel cell fuel and air from the fuel cell generator 5. These fluids are directed from the fuel cell stack 50 to dissipation media in the fluid dissipater 10. The dissipation media are exposed to an air stream blown by the cooling system fan 70 through the cooling system radiator 80 and through the dissipation media assembly 20, which serves to quickly dissipate the fluids into the air stream and discharge the fluids from the fuel cell generator 5 to the environment. The fluid dissipater 10 operates to completely remove excess fluids to the environment. The fluid dissipater 10 also operates to safely dilute unreacted fuel to the environment.

The enclosure air inlet 58 is coupled to the air inlet particulate filter 59. The filter 59 prevents the incursion of air-borne particulate matters into the interior of the fuel cell generator enclosure 54. During operation of the fuel cell generator 5, the cooling system fan 70 operates, drawing air through the enclosure air inlet 58 into the interior of the fuel cell generator enclosure 54, and then through the dissipation media assembly 20. Inclusion of the particulate air filter 59 ensures that the air stream that enters the fluid dissipater 10 does not contain particulate matter. A suitable air particulate filter is provided by Web Products Inc., under the name Three Phase Electrostatic Filter, however, other particulate filters having similar properties can be substituted within the scope of this invention.

Air leaves the dissipation media assembly 20 into the interior of the enclosure 54. Close spacing of the dissipation media assembly 20 to the enclosure air outlet 55 and perimeter sealing of the air path from the dissipation media assembly 20 to the enclosure air outlet 55 allows the entire air stream to immediately pass through the enclosure air outlet 55 to the environment.

During operation of the fuel cell generator 5, excess fuel cell fluids flow through the fuel cell excess fluids outlet 11 and the excess fluids conduit 7 due partially to the pressure they receive from the operation of the fuel cell generator 5 and partially through the force of gravity. The excess fluids may at times consist of one or more different fluids depending on the operational state of the coupled fuel cell generator 5. The excess fluids may include liquid water, water vapour, unreacted fuel cell fuel and air; the fuel cell fuel typically being gaseous hydrogen.

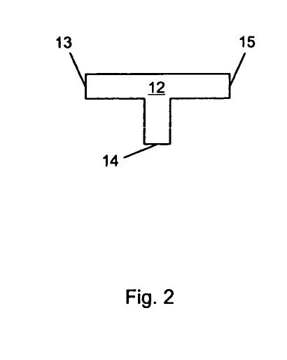

Referring to FIG. 2, the fluid separator 12 includes a fluid inlet 13, a water outlet 14 and a gas outlet 15. In this embodiment of the invention, the excess fuel cell fluids stream passes from the fuel cell excess fluids outlet 11 through the excess fluids conduit 7 and the fluid inlet 13 into the fluid separator 12. Water in the fluid stream settles by gravity to the bottom portion of the fluid separator 12 and exits the fluid separator 12 by way of the water outlet 14. The water may include some entrained gases. The gases in the fuel cell fluids stream rise to the top portion of the fluid separator 12 and exit the fluid separator 12 by way of the gas outlet 15. The gases may include air, unreacted gaseous fuel cell fuel and water vapour. The gases may include some entrained liquid water.

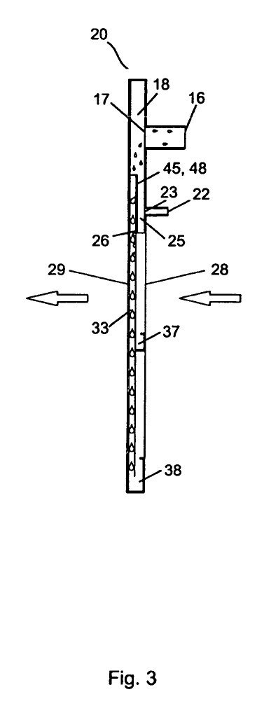

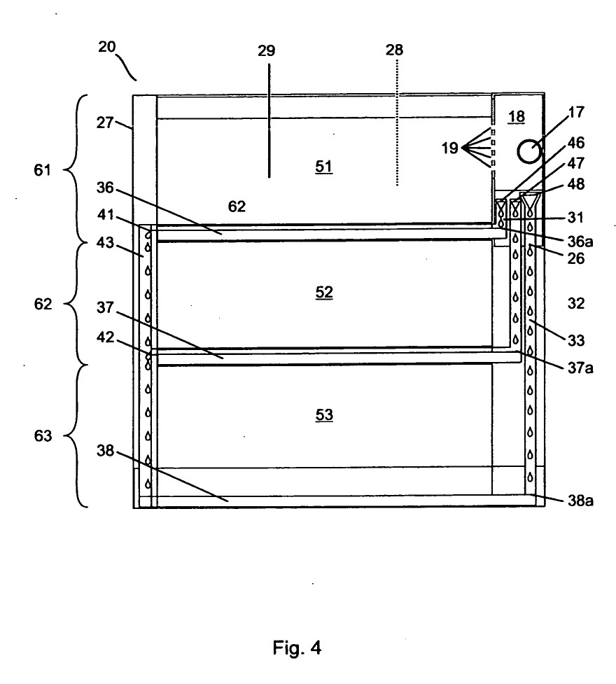

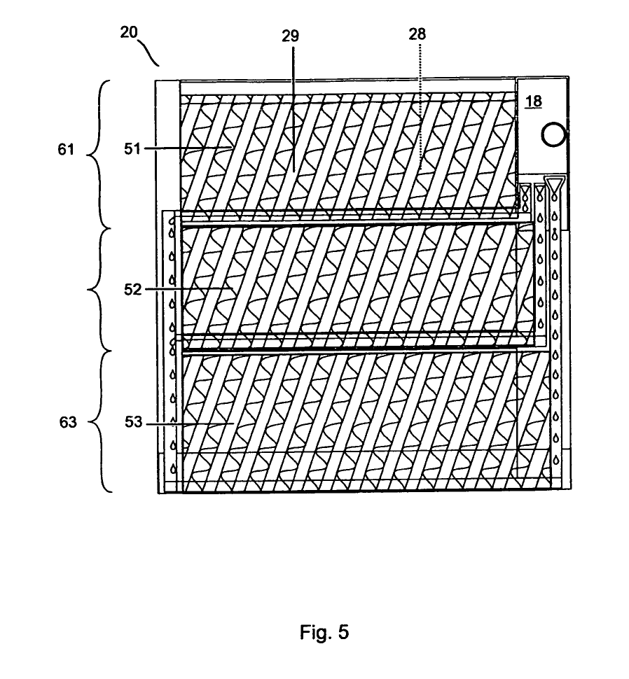

Referring to FIGS. 3-5, the dissipation media assembly 20 includes an air inlet 28, an air outlet 29, a water inlet port 22 and a gas inlet port 16. The dissipation media assembly 20 also includes a frame 27, a gas inlet 17, a gas distribution chamber 18, a gas distribution outlet 19, the water inlet port 22, a water inlet 23, a water distribution chamber 25, a water distribution chamber bleed hole 26, a V-notch weir 45, a first water conduit 31, a second water conduit 32, a third water conduit 33, a first overflow outlet 41, a second overflow outlet 42, an overflow conduit 43, a first water trough 36, a second water trough 37, a third water trough 38, a first dissipater section 61, a second dissipater section 62, and a third dissipater section 63, a first dissipation medium 51, a second dissipation medium 52, and a third dissipation medium 53. These components excluding the media 51 52, 53 are considered part of a fluid intake assembly that serves to direct fluids from the fuel cell stack 50 to the media 51, 52, 53.

The gas stream is directed from the gas outlet 15 by way of the excess gas conduit 9 to the gas inlet port 16 and a gas inlet 17 into a gas distribution chamber 18 of the dissipation media assembly 20.

The gas distribution chamber 18 is vertically continuous to the water distribution chamber 25, such that liquid water entrained in the gas stream may precipitate downward from the gas distribution chamber 18 into the water distribution chamber 25.

From the gas distribution chamber 18, the gas stream flows through the gas distribution outlet 19 into the first dissipater section 61 where the gas stream flows into the first dissipation medium 51 and the adjacent air space, where the gases dissipate further according to the properties of the constituent gases.

In this embodiment, the gas distribution outlet 19 comprises a plurality of orifices; however, a single orifice could be used without detracting from the invention.

The air stream flowing through the dissipation media assembly 20 (via air inlet 28 and air outlet 29) increases the speed of gas dissipation through the enclosure air outlet 55 to the environment.

The water stream is conveyed from the water outlet 14 by way of the excess water conduit 8 to the water inlet port 22 and the water inlet 23 into a water distribution chamber 25 of the dissipation media assembly 20.

Gas entrained in the water stream may rise into the gas distribution chamber 18.

The water distribution chamber 25 is vertically elongate and has the bleed hole 26 near the bottom of the chamber and the V-notch weir 45 part way up one side of the chamber. The V-notch weir 45 includes a first V-notch port 46, a second V-notch port 47 and a third V-notch port 48 all having a bottom edge at the same height within the water distribution chamber 25 and in which the third V-notch port 48 is taller than the first and second V-notch ports 46, 47. When the water in the chamber 25 reaches the bottom level of the V-notch weir 45, the water flows simultaneously into the bottom of the V-notch ports 46, 47, 48 and therethrough into the first water conduit 31, the second water conduit 32, and the third water conduit 33 respectively. When the water in the water distribution chamber 25 rises above the bottom level of the V-notch weir 45, the flow of water through V-notch ports 46, 47, 48 increases according to the width of the V-notches at that level. When the water in the chamber 25 rises above the top level of the first and second V-notch ports 46, 47, the flow of water through V-notches 46, 47 cannot increase further, and the flow of water through the third V-notch port 48 increases according to the width of the V-notch at that level.

The bleed hole 26 is sized to allow a slow bleeding of water out of the water distribution chamber 25 into the third water conduit 33. The inclusion of the bleed hole 26 allows the water distribution chamber 25 to drain when water is not entering the fluid dissipater 10, for example when the fuel cell generator 5 shuts down.

The water stream entering the dissipation media assembly 20 varies during operation of the fuel cell generator 5, resulting in surges of water entering the water distribution chamber 25. Emptying of the water distribution chamber 25 during no-flow periods provides a water volume buffer for when a surge of water enters the fluid dissipater 10, such as when the fuel cell generator 5 starts up, or when a fuel cell purge valve (not shown) opens.

In this arrangement, a non-excessive steady stream of water is distributed evenly through the three V-notch ports 46, 47, 48 into the three respective water conduits 31, 32, 33; while a surge in the water stream causes some or all of the additional water to enter the third V-notch port 48 and therethrough into the third water conduit 33; and at all times when water is present in chamber 25, the water bleeds through bleed hole 26 into the third water conduit 33. The rate of water flow through the bleed hole 26 is less than the flow of water through the V-notch weir 45 whenever water is flowing through the V-notch weir.

The provision of a water distribution chamber 25 to contain a volume of water, a bleed hole 26 to empty water from the bottom of the chamber 25 into the third water conduit 33, and a third V-notch port 48 that is larger than a first and a second V-notch port 46, 47 allows the fluid dissipater 10 to distribute the water stream to the water conduits 31, 32, 33 preferentially to the third water conduit 33.

Alternatively, the bottom of one or two of the V-notch ports 46, 47, 48 can be at different levels, and the V-notch ports can be of different sizes or shapes. The V-notch weir 45 can alternatively contain a different number of V-notch ports.

First, second and third water conduits 31, 32, 33 are largely vertically elongate such that water flows downward through them under the force of gravity. The first water conduit 31 is coupled to the first water trough inlet 36a and the first water trough 36, such that the water stream in the first water conduit 31 flows downward into the first water trough inlet 36a and the first water trough 36. The second water conduit 32 is coupled to the second water trough inlet 37a and the second water trough 37, such that the water stream in the second water conduit 32 flows downward into the second water trough inlet 37a and the second water trough 37. The third water conduit 33 is coupled to the third water trough inlet 38a and the third water trough 38, such that the water stream in the third water conduit 31 flows downward into the third water trough inlet 38a and the third water trough 38.

The first water trough 36 and the second water trough 37 are designed to have a minimal vertical dimension to minimize obstruction of the air stream. In this embodiment, the first water trough 36 and the second water trough 37 are each less than fifteen (15) millimeters in height.

First, second and third water troughs 36, 37, 38 are largely horizontally elongate, such that water in the troughs spreads evenly along the tray. The third water trough 38 is larger in liquid capacity than each of the first and second water troughs 36, 37; the larger liquid capacity corresponding to the larger water flow that may traverse the third water conduit 33.

The dissipation media assembly 20 is largely divided into three largely horizontal dissipater sections, the first dissipater section 61 located above the second dissipater section 62, and the second dissipater section 62 located above the third dissipater section 63. The bottom edge of the first dissipater section 61 is defined by the bottom of the first water trough 36. The bottom edge of the second dissipater section 62 is defined by the bottom of the second water trough 37. The bottom edge of the third dissipater section 63 is defined by the bottom of the third water trough 38.

The first dissipation medium 51 is located within the first dissipater section 61 and the bottom edge of the first dissipation medium 51 is located within the first water trough 36. The second dissipation medium 52 is located within the second dissipater section 62 and the bottom edge of the second dissipation medium 52 is located within the second water trough 37. The third dissipation medium 53 is located within the third dissipater section 63 and the bottom edge of the third dissipation medium 53 is located within the third water trough 38. Dissipation media are well known and have been described as contact bodies, flocking, evaporator pads, and evaporator paper. A suitable dissipation medium for this invention is a cellulose product provided by the Columbus Industries Inc. under the description WICK MDNB; however, other dissipation media that have similar gas permeable and water absorbing and evaporative properties can be substituted within the scope of this invention.

The positioning of a dissipation medium such that the bottom edge of the medium is within a water trough causes water in the water trough to wick upwards naturally through the dissipation medium. The dissipation media 51, 52, 53 are each limited in height to within the range of height to which water can wick naturally for the dissipation media. In operation, water in the first water trough 36 is wicked into the first dissipation medium 51, water in the second water trough 37 is wicked into the second dissipation medium 52, and water in the third water trough 38 is wicked into the third dissipation medium 53.

Water in the dissipation media 51, 52, 53 evaporates naturally according to ambient temperature and humidity conditions, and additionally according to air flow rate.

In this embodiment, the water conduits 31, 32, 33 are directly coupled to their respective troughs 36, 37, 38 without any intervening barrier, orifice or restriction. Alternatively, one or more of the water conduits may include a barrier, orifice or restriction (not shown) to reduce the incidence of splashing or to reduce water flow; for example, an orifice can be located in the side of the water conduits 31, 32, 33 with the bottom level of the orifice located between the top and bottom levels of the water troughs 36, 37, 38 respectively.

Optionally, the water conduits 31, 32, 33 can contain respective orifices (not shown) that allow water to pass from the conduit 31, 32, 33 to the side edge of the respective dissipation medium 51, 52, 53, thereby wicking into the medium 51, 52, 53 respectively. Alternatively, water passes from the second water conduit 32 through an orifice (not shown) and comes into contact with a side edge of the first dissipation medium 51 and thereby wicks into the medium. likewise, water passes from the third water conduit 33 through an orifice (not shown) and come into contact with a side edge of the first dissipation medium 51 and/or the second dissipation medium 52 and thereby wicks into the medium.

The first water trough 36 has the first overflow outlet 41. The first overflow outlet 41 may be a passage or passages through a side of the first water trough 36, or the outlet 41 may be a portion or portions of a side of the trough 36 that is lower than the remainder of the trough's sides. During operation, the water stream may enter the first water trough 36 at a flow that is greater than the evaporative capacity of the first dissipation medium 51, resulting in an increasing water level within the first water trough 36. When the water level in the first water trough 36 increases to the level of the first overflow outlet 41, a first overflow water stream traverses the first overflow outlet 41 and enters the overflow conduit 43. The second water trough 37 has a similar overflow outlet 42 and a second overflow water stream.

The overflow conduit 43 is largely vertically elongate such that the overflow water streams flow downward through the overflow conduit 43 under the force of gravity. The overflow conduit 43 conveys the first overflow water stream and the second overflow water stream to the third water trough 38.

In an alternate embodiment, the water troughs 36, 37, 38 additionally each have an overflow outlet (not shown) that conveys overflow water to the third water conduit 33. In another alternate embodiment, the water troughs 36, 37, 38 have an overflow outlet that conveys overflow water to the third water conduit 33 instead of the first and second overflow outlets 41, 42. In these embodiments, the inclusion of overflow outlets at both ends of the first and second water troughs 36, 37 prevents water from spilling out of the troughs in the event that the fuel cell generator 5 becomes tilted.

In this embodiment, the overflow conduit 43 is directly coupled to the first water trough 36 without any intervening barrier, orifice or restriction. In an alternate embodiment, the water stream in the overflow conduit 43 traverses a fourth water trough water inlet (not shown) into the third water trough 38. The fourth water trough water inlet (not shown) may consist of a barrier, orifice or restriction that functions to reduce splashing or reduce water flow. In this case, the fourth water trough water inlet consists of an orifice in the side of the overflow conduit 43, the bottom of the orifice located above the bottom of the third water trough 38, and below the top of the third water trough 38.

Fuel cell power system startup is characterized by the flushing of accumulated water from the fuel cell stack 50 and associated components. Fuel cell power system fuel purge may be accompanied by the flushing of water from the fuel cell stack 50 and associated components. Flushing accumulated water from fuel cell stacks 50 like the Ballard Power Systems Mark 9 series stack used in this invention are well known in the art and therefore not described here.

Flushing of accumulated water can cause a large surge of water into the fluid dissipater 10. The large surge of water may quickly fill the water distribution chamber 25 such that the water level rises to cover all of the V-notch ports 46, 47, 48. The additional water accumulates within the water distribution chamber 25, raising the level of water within the chamber 25. As the water distribution chamber 25 is vertically continuous with the gas distribution chamber 18, a large surge of water entering the water distribution chamber 25 can raise the water level within the water distribution chamber 25 such that the water occupies the gas distribution chamber 18. The water's occupation of the gas distribution chamber 18 is temporary because water is continuously being reduced through water traverse of the bleed hole 26 and the V-notch weir 45. During the water's occupation of the gas distribution chamber 18, whenever the water rises to cover even part of the gas distribution outlet 19, water traverses the gas distribution outlet 19 into the first dissipater section 61; the water comes into contact with the first dissipation medium 51 and is largely absorbed by the dissipation medium 51. The gas distribution outlet 19 is preferentially located to bring fluids into contact with the first dissipation medium 51 near the top edge of the medium such that water traversing the gas distribution outlet 19 contacts the dissipation medium 51 distantly from the first water trough 36. In this way, a large surge of water from the fuel cell generator 5 that overfills the water distribution chamber 25 is conveyed to a dissipation medium without overflowing from the dissipation media assembly 20.

Alternatively, water in the gas distribution chamber 18 can be routed to the second dissipater section 62 or the third dissipater section 63, or any combination of dissipater sections 61, 62, 63 within the scope of the invention.

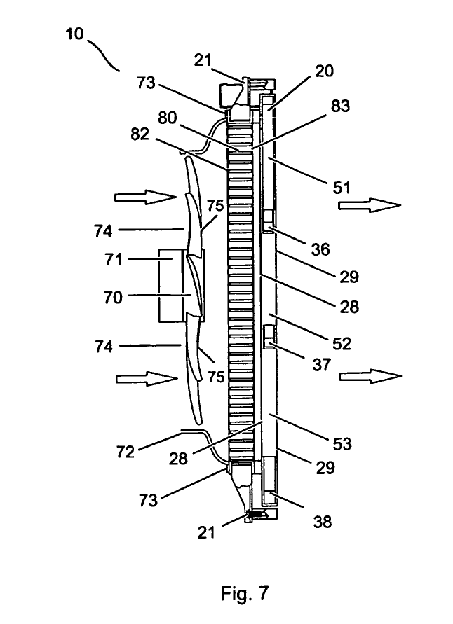

Referring to FIG. 7, the cooling system fan 70 includes a cooling fan air inlet 74 and cooling fan air outlet 75 and a cooling fan motor 71. Much of the air stream within the enclosure 54 is drawn by the cooling system fan 70 through the cooling fan air inlet 74 into the cooling system fan 70. The cooling system 70 fan blows the air sequentially through a cooling fan air outlet 75, the radiator air inlet 82, the radiator 80 and the radiator air outlet 83, the dissipater air inlet 28, the dissipation media 51, 52, 53, the dissipater air outlet 29, and the enclosure air outlet 55 to the environment.

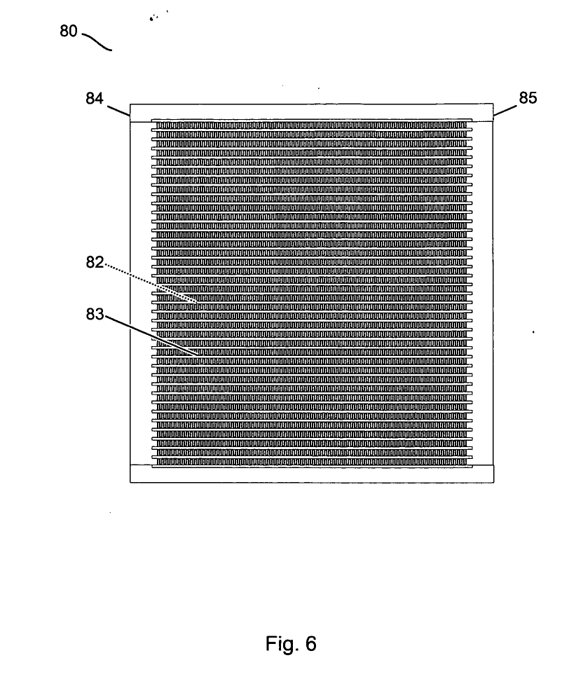

Referring to FIG. 6, the radiator 80 includes a radiator air inlet 82, and a radiator air outlet 83. The radiator 80 is part of the fuel cell generator's cooling system, and is arranged to input heated water through a radiator water inlet 84 and output cooled water through a radiator water outlet 85. The radiator used here is a standard type of radiator that is well known, including a plurality of water conduits shaped to maximize water conduit surface area between the radiator water inlet 84 and the radiator water outlet 85. The conduit surfaces serve to transfer heat from the heated water within the water conduits to the air surrounding the water conduits. In this embodiment, the radiator is arranged in close proximity to the cooling system fan 70 such that air impelled by the cooling system fan 70 enters the radiator air inlet 82, makes contact with the radiator's plurality of water conduits and exits through the radiator air outlet 83. In this arrangement, heat from the radiator 80 is transferred to the air, which in turn transfers heat to the dissipation media 51, 52, 53 and the water in the dissipation media, thereby speeding evaporation of the water.

Referring to FIG. 7, the radiator 80 has one or more fasteners 21 that attach the radiator 80 to the fluid dissipater frame 27; however, the radiator 80 could be fastened in another manner and to another fuel cell generator component within the scope of the invention. A cooling fan shroud 72 surrounding the cooling fan 70 and attached to the radiator 70 by way of fasteners 73 allows the entire air stream from the cooling fan air outlet 75 to traverse the radiator 80.

A radiator-to-dissipater seal (not shown) attached to the periphery of the radiator 80 and the periphery of the dissipation media assembly 20 is provided to prevent the incursion of air into the interior of the fuel cell enclosure during operation. The prevention of incursion of air into the interior of the fuel cell enclosure during operation ensures that the air stream flows directly from the radiator to the dissipation media assembly 20. The radiator-to-dissipater seal is made of a high temperature tolerant adhesive film tape, provided by Shercon Inc., under the part number PC21, but may be another adhesive film tape or another sealing material without detracting from the invention.

The air stream flowing through the dissipation media 51, 52, 53 speeds evaporation of wicked water in the media, and dissipation of the gas in the dissipation medium 51.

A dissipater-to-enclosure seal (not shown) attached to the periphery of the dissipation media assembly 20 and the periphery of the enclosure air outlet 55 is provided to prevent the incursion of air into the interior of the fuel cell enclosure during operation. The prevention of incursion of air into the interior of the fuel cell enclosure during operation ensures that the air stream flows directly from the dissipation media assembly 20 to the enclosure air outlet 55 and the environment.

The dissipater-to-endosure seal is made of a high temperature tolerant adhesive film tape, provided by Shercon Inc., under the part number PC21, but may be another adhesive film tape or another sealing material without detracting from the invention.

In an alternate embodiment of this invention, where a fuel cell generator 5 has a cooling system in which the cooling fan is located downstream of the radiator, and the cooling fan sucks air through the radiator, the dissipation media assembly 20 is preferentially located between the radiator and the cooling fan, or between the cooling fan and the enclosure air outlet 55.

In another alternate embodiment of this invention, the radiator 80 may be deleted. In this case, the cooling fan shroud 72 is attached directly to the dissipation media assembly 20.

A particular advantage of the fluid dissipater 10 as described above is that the fluid dissipater 10 operates to dissipate fluid without the need for external power or control. Therefore, the fluid dissipater 10 does not impose a parasitic power loss to the system 5, nor requires the added expense and complexity of a controller.

The fluid dissipater 10 should be designed to accommodate variations in fuel cell generator 5 operation. For example, a controller (not shown) can vary the rate of power generation of the fuel cell stack 50 by changing the air flow rate to the fuel cell stack 50. Such change in air flow rate affects the fluid dissipation rate by the fluid dissipater 10. Selection of the fluid dissipater 10 components such as the type of dissipation media 51, 52, 53, and the size and shape of water troughs 36, 37, 38 should therefore be made to ensure that the fluid dissipater 10 can handle the full range of excess fluids output by the fuel cell generator 5.

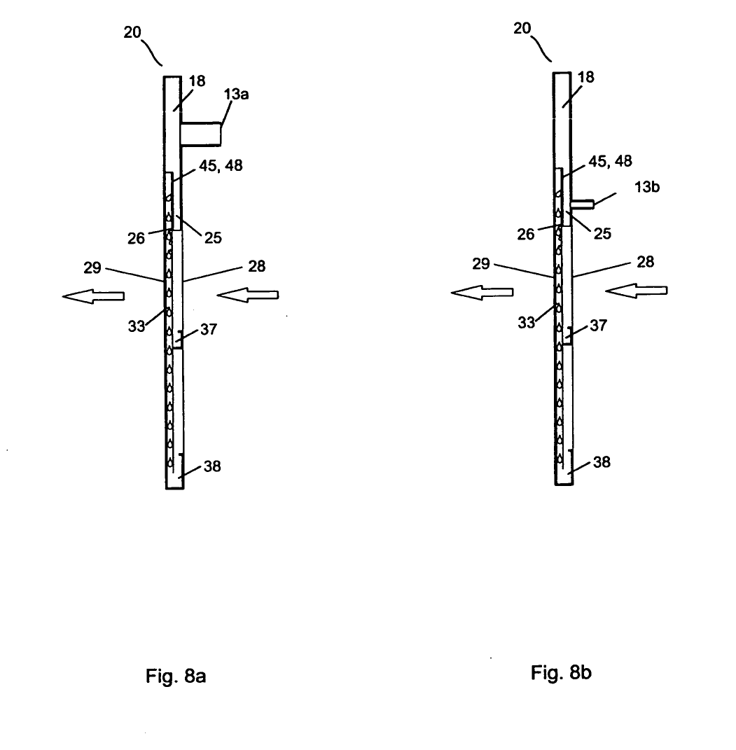

According to other embodiments of the invention, a separate fluid separator 12 is not used, and fluid separation takes place within the dissipation media assembly 20. In one such embodiment and referring to FIG. 8a, the excess fuel cell fluids stream from the fuel cell excess fluids outlet 11 traverses the excess fluids conduit 7 to the fluid inlet 13a of the dissipation media assembly 20 and into the gas distribution chamber 18. The gas distribution chamber 18 is vertically elongate and is above and continuous with the water distribution chamber 25. In operation, the excess fluids in the gas distribution chamber 18 separate naturally with the liquids falling under the force of gravity into the water distribution chamber 25, and the gases occupying the gas distribution chamber 18. The water may contain some entrained gases, and the gases may include some water vapour.

In another such embodiment, and referring to FIG. 8b, the excess fuel cell fluids stream from the fuel cell excess fluids outlet 11 traverses the excess fluids conduit 7 to the fluid inlet 13b of the dissipation media assembly 20 and into the water distribution chamber 25. In operation, the excess fluids in the water distribution chamber 25 separate naturally with the gases rising into the gas distribution chamber 18, and the liquids occupying the water distribution chamber 25. The water may contain some entrained gases, and the gases may include some water vapour.

In another such embodiment, the fluid inlet can be located between the locations of fluid inlet 13a and fluid inlet 13b, as long as the fluids are conveyed to either the water distribution chamber 25 or the gas distribution chamber 18, or otherwise distributed to the two chambers 25, 18.

In an alternate embodiment, the fluid dissipater 10 incorporates a motor actuated water pump (not shown) and a return water conduit (not shown) provided to convey water from the third water trough 38 to the water distribution chamber 25. The power to power the motor of the motor actuated water pump comes from the fuel cell generator 5. In this embodiment the water pump operates continuously whenever the fuel cell generator 5 is operating.

In a further alternate embodiment, the fluid dissipater 10 incorporates a high water level sensor (not shown) in the third water trough 38 provided to sense a high water level and capable of sending a signal to a controller such as a fuel cell power system controller (not shown). The water pump of this embodiment is activated by a signal from the controller, whenever the high level water sensor is triggered.

In further alternate embodiments, the fluid dissipater 10 incorporates a motor actuated water pump (not shown) and a supply water conduit (not shown) provided to convey water from one of the excess fluids outlet 11 and the water outlet 14 to one or more of the water distribution chamber 25, the gas distribution chamber 18, the first, second and third water troughs 36, 37, 38, the first, second, and third water conduits 31, 32, 33, and the overflow conduit 43.

It is to be understood that even though various embodiments and advantages of the present invention have been set forth in the foregoing description, the above disclosure is illustrative only, and changes may be made in detail, and yet remain within the broad principles of the invention. Therefore, the present invention is to be limited only by the claims appended to the patent.

What is claimed is:

1. A fuel cell generator comprising:
a fuel cell; and
a fluid dissipater comprising:
a gas permeable and water absorbing evaporative media; and
a fluid intake assembly fluidly coupled to the evaporative media and to the fuel cell such that water and gaseous unreacted fuel discharged by the fuel cell are directed to the evaporative media for dissipation out of the fuel cell system.

2. A fuel cell generator as claimed in claim 1 wherein the fluid intake assembly comprises a water trough fluidly coupled to the fuel cell such that water discharged by the fuel cell is directed to the trough, and wherein the evaporative media is located in sufficient proximity to the trough to wick water in the trough into the media.

3. A fuel cell generator as claimed in claim 2 wherein the fluid intake assembly comprises a gas conduit having an inlet end fluidly coupled to the fuel cell and an outlet end fluidly coupled to the evaporative media, such that the fuel discharged from the fuel cell is directed into the media.

4. A fuel cell generator as claimed in claim 3 wherein the fluid intake assembly further comprises a fluid separator having a chamber fluidly coupled to a fluid exhaust stream from the fuel cell, a water outlet for directing water that has settled in the chamber into the trough, and a gas outlet for directing fuel from the exhaust stream to the gas conduit.

5. A fuel cell generator as claimed in claim 4 wherein the fluid intake assembly further comprises a fluid separation chamber fluidly coupled to the media, a gas inlet fluidly coupled to the gas conduit, a water inlet fluidly coupled to the fluid separator water outlet, and a water outlet located below the gas and water inlets and fluidly coupled to the trough.

6. A fuel cell generator as claimed in claim 1 further comprising a fan facing the evaporative media and configured to direct an air stream through the media to dissipate water and fuel in the media out of the fuel cell system.

7. A fuel cell generator as claimed in claim 6 wherein an oxidant intake of the fuel cell is in fluid communication with the air stream.

8. A fuel cell generator as claimed in claim 6 further comprising a radiator thermally coupled to the fuel cell and having heat exchanger elements located between the fan and the media such that heat is discharged from the heat exchanger elements into the air stream.

9. A fuel cell generator as claimed in claim 3 wherein a lower portion of the media is positioned to contact water in the trough, and an upper portion of the media is positioned to receive fuel from the gas conduit.

10. A fuel cell generator as claimed in claim 2 wherein the intake assembly further comprises a fluid separation chamber in fluid communication with the media, a fluid inlet fluidly coupled to the exhaust stream, and a water outlet fluidly coupled to the trough and located below the fluid inlet to collect water that falls out of the exhaust stream when entering the chamber.

11. A fuel cell generator as claimed in claim 3 wherein the dissipater comprises multiple troughs and multiple evaporative media each located in sufficient proximity to an associated trough to wick water in the trough into the media.

12. A fuel cell generator as claimed in claim 5 further comprising a pump fluidly coupled to the trough and to the chamber and configured to pump water from the trough into the chamber.

13. A fuel cell generator as claimed in claim 12 further comprising a sensor in the trough and communicative with the pump and wherein the pump is configured to pump water when the sensor detects a high water level in the trough.

14. An apparatus for dissipating fluids from a fuel cell generator, comprising:
a gas permeable and water absorbing evaporative media; and
a fluid intake assembly fluidly coupled to the evaporative media and to a fuel cell such that water and gaseous unreacted fuel discharged by the fuel cell are directed to the evaporative media for dissipation out of the fuel cell generator.

15. An apparatus as claimed in claim 14 wherein the fluid intake assembly comprises a water trough fluidly coupled to the fuel cell such that water discharged by the fuel cell is directed to the trough, and wherein the evaporative media is located in sufficient proximity to the trough to wick water in the trough into the media.

16. An apparatus as claimed in claim 15 wherein the fluid intake assembly comprises a gas conduit having an inlet end fluidly coupled to the fuel cell and an outlet end fluidly coupled to the evaporative media, such that the fuel discharged from the fuel cell is directed into the media.

17. An apparatus as claimed in claim 16 wherein the fluid intake assembly further comprises a fluid separator having a chamber fluidly coupled to a fluid exhaust stream from the fuel cell, a water outlet for directing water that has settled in the chamber into the trough, and a gas outlet for directing fuel from the exhaust stream to the gas conduit.

18. An apparatus as claimed in claim 17 wherein the fluid intake assembly further comprises a fluid separation chamber fluidly coupled to the media, a gas inlet fluidly coupled to the gas conduit, a water inlet fluidly coupled to the fluid separator water outlet, and a water outlet located below the gas and water inlets and fluidly coupled to the trough.

19. An apparatus as claimed in claim 18 further comprising a pump fluidly coupled to the trough and to the chamber and configured to pump water from the trough into the chamber.

20. An apparatus as claimed in claim 19 further comprising a sensor in the trough and communicative with the pump and wherein the pump is configured to pump water when the sensor detects a high water level in the trough.
